(19) United States
(12) Patent Application Publication
(10) Pub. No.: US 2011/0047604 A1
(43) Pub. Date: Feb. 24, 2011

(54) COMPUTING INPUT SYSTEM WITH SECURE STORAGE AND METHOD OF OPERATION THEREOF

(75) Inventors: Lev M. Bolotin, Kirkland, WA (US); Simon B. Johnson, Bonney Lake, WA (US)

Correspondence Address: LAW OFFICES OF MIKIO ISHIMARU, 333 W. EL CAMINO REAL, SUITE 330, SUNNYVALE, CA, 94087, US

(73) Assignee: CLEVX, LLC, Kirkland, WA (US)

(21) Appl. No.: 12/933,418

(22) PCT Filed: Mar. 18, 2009
(86) PCT No.: PCT/US2009/037587

§ 371 Date: Sep. 18, 2010

Related U.S. Application Data
(60) Provisional application No. 61/037,541, filed on Mar. 18, 2008.

(51) Int. Cl. H04L 9/32; G06F 21/02; G06F 12/14; G06F 3/033

(52) U.S. Cl. 726/5

(57) ABSTRACT

A method (700) of operation of a computing input system (100) includes: entering a memory access code (118) with a button (102), a wheel (106), or a device transceiver (612) for a non-physical mechanism (614); verifying the memory access code (118) with an authentication module (208); and enabling a secure storage sub-system (206) with the memory access code (118) verified by the authentication module (208) for accessing the secure storage sub-system (206) from an external computing device (202).

### CROSS-REFERENCE TO RELATED APPLICATION(S)

This application claims the benefit of U.S. Provisional Patent Application Ser. No. 61/037,541 filed Mar. 18, 2008, and the subject matter thereof is incorporated herein by reference thereto.

### TECHNICAL FIELD

The present invention relates generally to a computing input system, and more particularly to a computing input system with a secure storage.

### BACKGROUND ART

The use of personal computers in both the home and office has become everyday activities. These computers provide a high level of functionality to many people at a moderate price, substantially surpassing the performance of the large mainframe computers of only a short while ago. Laptop and notebook computers, which provide high-performance computing power on a mobile basis, are becoming even more common.

The widespread availability of personal computers has had a profound impact on interpersonal communications as well. Today, a growing number of businesses and individuals communicate via electronic mail (e-mail) on the Internet. Personal computers have also been instrumental in the emergence of the Internet and its growing use as a medium of commerce with Internet portals and kiosks being commonplace.

With the increasing importance of personal computing devices, the data being stored on these devices have become increasingly important and the need to backup data to a separate medium has become even more important and critical. Creating computer backups are problematic. Computer resident drives can be compromised leaving information inaccessible and the computer unable to operate. To be effective, backups must be performed on a regular basis, which people often forget to do.

Further, backup storage often requires another device or mass storage unit. Such a device may not be handy at all times, especially when used with laptops that can travel from one area to another. In addition, performing backups can be time consuming.

Backups are usually performed by copying data from a resident hard drive to an external medium such as portable hard drive, flash drive, CD, floppy disk, or tape. A software backup utility is often required to automate and make the job of backing up easier. However, since backing up is often not convenient or easy to remember, backup intervals are often long and backups are often not made on a regular basis, with catastrophic consequences for the users.

Backups, once created, need to be protected from unauthorized access in much the same manner as the original data. The implementation of secure access policies are even more problematic and complex, if backups are created that have public access.

Thus, a need still remains for a computing input system providing low cost, ease of use, and security. In view of the ever-increasing need to provide cost savings, convenience, storage, and protection of data, it is increasingly critical that answers be found to these problems.

In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a computing input system including: entering a memory access code with a button, a wheel, or a device transceiver for a non-physical mechanism; verifying the memory access code with an authentication module; and enabling a secure storage sub-system with the memory access code verified by the authentication module for accessing the secure storage sub-system from an external computing device.

The present invention provides a computing input system including: a button, a wheel, or a device transceiver, for a non-physical mechanism, for entering a memory access code; an authentication module, coupled to a display, for verifying the memory access code; and a secure storage sub-system, coupled to the authentication module, enabled with the memory access code verified by the authentication module for accessing the secure storage sub-system from an external computing device.

Certain embodiments of the invention have other steps or elements in addition to or in place of those mentioned above. The steps or element will become apparent to those skilled in the art from a reading of the following detailed description when taken with reference to the accompanying drawings.

### BRIEF DESCRIPTION OF THE DRAWINGS

FIG. 1 is a top view of a computing input system in a first embodiment of the present invention.

FIG. 2 is a system diagram of the computing input system of FIG. 1 in an example application.

FIG. 3 is a detailed diagram of the secure storage sub-system of FIG. 2.

FIG. 4 is a detailed diagram of the intelligent input-output controller of FIG. 2.

FIG. 5 is a system diagram of a computing input system in an example application in a second embodiment of the present invention.

FIG. 6 is a system diagram of a computing input system in an example application in a third embodiment of the present invention.

FIG. 7 is a flow chart of a method of operation of a computing input system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation.

Where multiple embodiments are disclosed and described having some features in common, for clarity and ease of illustration, description, and comprehension thereof, similar and like features one to another will ordinarily be described with similar reference numerals. The embodiments have been numbered first embodiment, second embodiment, etc. as a matter of descriptive convenience and are not intended to have any other significance or provide limitations for the present invention.

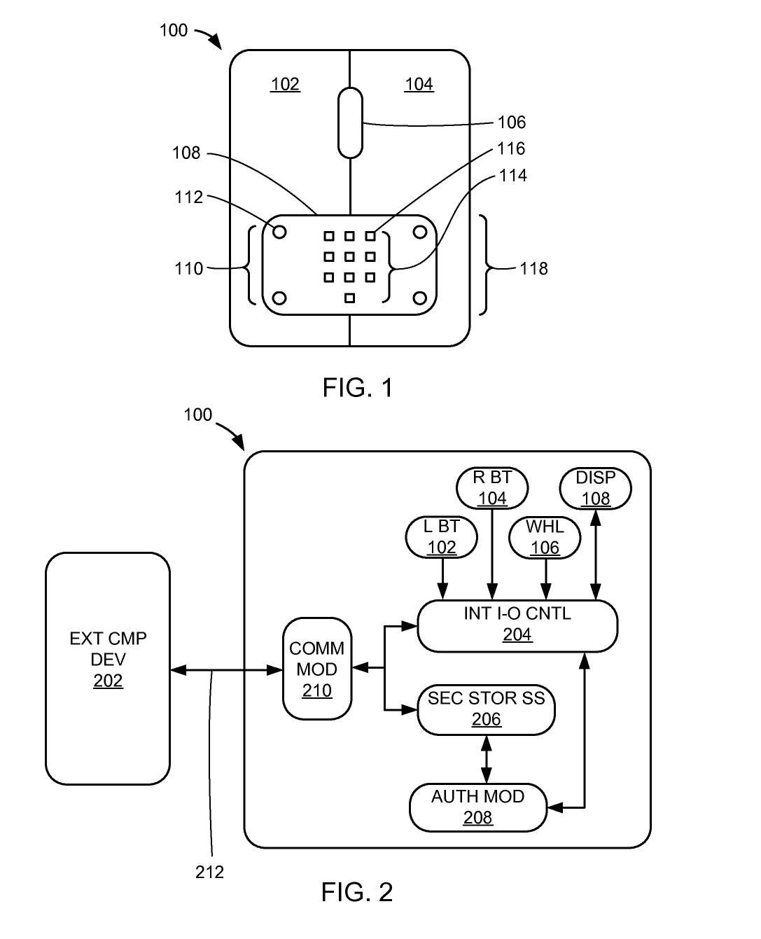

Referring now to FIG. 1, therein is shown a top view of a computing input system 100 in a first embodiment of the present invention. The top view depicts the computing input system 100 having a left button 102, such as a mouse button, a control button, or an input mechanism. The top view depicts the computing input system 100 having a right button 104, such as a mouse button, a control button, or an input mechanism.

For illustrative purposes, the computing input system 100 is shown as a computer mouse with the left button 102 and the right button 104, although it is understood that the computing input system 100 can be a different human interface device with type and number of buttons and/or other input/output means. For example, the computing input system 100 can be a remote keypad device or a memory device.

Also for illustrative purposes, the computing input system 100 is shown as a computer mouse with the left button 102 and the right button 104, although it is understood that the computing input system 100 can include different input/output means. For example, the computing input system 100 can include a joy stick.

The computing input system 100 can include a wheel 106, such as a thumbwheel a mouse button, a control button, an input mechanism, a scroll wheel, or a rolling track ball. The wheel 106 can be positioned between the left button 102 and the right button 104.

For illustrative purposes, the computing input system 100 is shown with the wheel 106 between the left button 102 and the right button 104, although it is understood that the computing input system 100 can include the wheel 106 positioned anywhere on the computing input system 100. For example, the wheel 106 can be positioned on a side of the computing input system 100.

Also for illustrative purposes, the computing input system 100 is shown with the wheel 106 as a wheel moving in two directions, although it is understood that the computing input system 100 can include the wheel 106 that can have more than two direction of movements. For example, the wheel 106 represent a track ball capable of moving in any unlimited number of directions as associated with a track ball.

The computing input system 100 can include a display 108, such as a display screen, a touch pad, a touch display, a sensor, or a combination thereof. For example, the display 108 can show a menu, provide a phone type numeric keypad, or show status information. Examples of status information are storage capacity, activity, or progress of a backup.

For illustrative purposes, the computing input system 100 is shown as a computer mouse with the display 108 below the wheel 106, although it is understood that the computing input system 100 can include the display 108 at a different position. For example, the display 108 can be above the wheel 106 on the computing input system 100.

The left button 102 and the right button 104 can be used to select a user option, invoke a menu, or perform a configurable function on the display 108. The wheel 106 can be used to scroll through a menu, which can be shown on the display 108.

The computing input system 100 can include a positional entry 110 as a means for entering a passcode for performing authentication. The positional entry 110 can be entered on the display 108 functioning as a touch pad. The display 108 can include a location 112 for entering the positional entry 110. The location 112 can be at any corner of the display 108, as an example. The positional entry 110 can be entered using a number of the location 112.

The computing input system 100 can include a keypad 114, which is used for performing authentication. The keypad 114 can be shown on the display 108. The keypad 114 can include a number of digits 116, which are numeric characters from 0 to 9. The digits 116 can be selected by touching the display 108 functioning as a touch pad.

The wheel 106 can be used to cycle through the digits 116, which can be shown on the display 108, for entering a memory access code 118, such as a Personal Identification Number (PIN) or a passcode. The memory access code 118 can be entered on the display 108 by entering the positional entry 110, with the display 108 functioning as a touch pad without the keypad 114 displayed on the display 108. The memory access code 118 can be entered on the display 108 by using the left button 102, the right button 104, or the wheel 106 to select the digits 116 shown on the display 108.

For illustrative purposes, the computing input system 100 is shown with the digits 116 in 10 numeric characters on the display 108, although it is understood that the computing input system 100 can include the digits 116 in a different configuration. For example, the computing input system 100 can include the digits 116 on the display 108 using two, four, or six numeric characters, as examples.

Referring now to FIG. 2, therein is shown a system diagram of the computing input system 100 of FIG. 1 in an example application. The system diagram depicts the computing input system 100 connected to an external computing device 202, such as a personal computer or an embedded computer.

The computing input system 100 can include an intelligent input-output controller 204, such as an embedded processor or mouse electronics. The intelligent input-output controller 204 can communicate with the external computing device 202.

The intelligent input-output controller 204 can be used to receive signals from the left button 102, the right button 104, the wheel 106, and the display 108 with the display 108 functioning as a touch pad, as an example. The intelligent input-output controller 204 can be used to send signals to the display 108.

The computing input system 100 can include a secure storage sub-system 206, such as a secure mass storage sub-system, a secure auxiliary storage sub-system, a secure non-volatile random access memory (NVRAM), a secure dynamic random access memory (DRAM), a secure static random access memory (SRAM), or a combination thereof. The secure storage sub-system 206 can be used for backing up computer data or storing confidential information. The secure storage sub-system 206 can be accessed using authentication, such as validating the PIN.

The computing input system 100 can include an authentication module 208 for granting or denying access to the secure storage sub-system 206. For example, the user can enter the memory access code 118 of FIG. 1 via a series of numeric codes, which can be shown on the display 108. The authentication module 208 can communicate with the intelligent input-output controller 204 to receive and verify the memory access code 118.

The authentication module 208 can be used to enable the secure storage sub-system 206 with the memory access code 118 verified by the authentication module 208 for accessing the secure storage sub-system 206 from the external computing device 202. A correct PIN for the memory access code 118 input to the authentication module 208 can grant access to the secure storage sub-system 206. If the PIN is incorrect, the authentication module 208 can deny access to the secure storage sub-system 206.

For example, the computing input system 100 can perform the authentication by using an external keypad of the external computing device 202 to enter the memory access code 118. The memory access code 118 can be sent to the authentication module 208.

As a second example, the computing input system 100 can perform the authentication by using the wheel 106 and the display 108. The wheel 106 can be used to cycle through the digits 116 of FIG. 1 shown on the display 108 to enter the memory access code 118.

For example, a three 2-digit combination gives one million possible combinations. For example, the three 2-digit combination can be entered by rolling the wheel 106 in one direction to enter the first 2-digit number, rolling the wheel 106 in an opposite direction to enter the second 2-digit number, and rolling the wheel 106 in another opposite direction to enter the third 2-digit number.

As a third example, the computing input system 100 can perform the authentication by using the display 108 functioning as a touch display with the keypad 114 presented to the user. The memory access code 118 can be entered using the keypad 114 on the display 108.

As a fourth example, the computing input system 100 can perform the authentication by using the authentication module 208 to receive a radio-frequency identification (RFID) tag. The RFID is an example of a non-physical mechanism for entering the memory access code 118. The RFID tag can be the memory access code 118 that is wirelessly transmitted using RF technology from an external key fob to the authentication module 208. A correct RFID tag in proximity can be used to grant access to the secure storage sub-system 206.

As a fifth example, the computing input system 100 can perform the authentication by entering the memory access code 118 using the location 112 of FIG. 1 on the display 108. For example, the location 112 can be at any one of the four corners of the display 108. The memory access code 118 can be entered by using a sequence of pressing the location 112 of the display 108.

The system diagram depicts the computing input system 100 having the intelligent input-output controller 204 and the secure storage sub-system 206 connected to a communication module 210, such as a hub or a bridge. The communication module 210 can support protocol such as universal serial bus (USB), FireWire, IEEE 1394, Radio Frequency (RF), Bluetooth, 802.11x, Wireless Fidelity (Wi-Fi), Infrared (IR), or any combination of wire and wireless technologies. The communication module 210 can be operated to receive data from the external computing device 202 for backing up the data into the secure storage sub-system 206.

The communication module 210 can enable the intelligent input-output controller 204 and the secure storage sub-system 206 to share a communication channel 212, such as a bus, an interface wire, or a wireless communication medium, to communicate with the external computing device 202. The communication channel 212 can be USB, FireWire, IEEE 1394, RF, Bluetooth, 802.11x, Wi-Fi, or IR.

It has been discovered that the present invention provides the computing input system 100 providing multi-function device. The computing input system 100 can provide multiple functions with the secure storage sub-system 206 for backing up computer data or storing confidential information as well as functioning as a computer mouse, as an example.

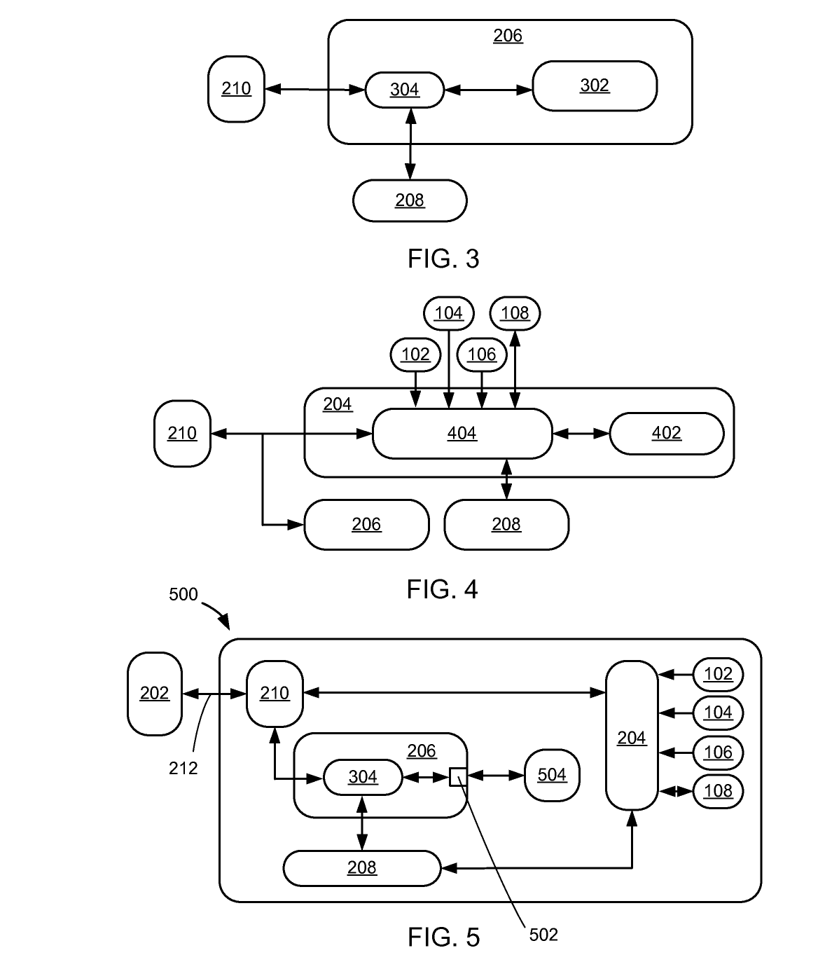

Referring now to FIG. 3, therein is shown a detailed diagram of the secure storage sub-system 206 of FIG. 2. The detailed diagram depicts the secure storage sub-system 206 having a storage device 302, such as Flash, SRAM, DRAM, NVRAM, read-only memory (ROM), or a combination thereof. The storage device 302 can retain data with the power supply off.

The secure storage sub-system 206 can include a security bridge 304, which can be a device that can encrypt and decrypt data. The security bridge 304 can connect the communication module 210 to the storage device 302. The security bridge 304 can be programmed in pass-through mode, in which the security bridge 304 simply transfers data without encryption and decryption.

For illustrative purposes, the computing input system 100 of FIG. 2 is described with the security bridge 304 performing encryption and decryption functions, although it is understood that the computing input system 100 can operate the security bridge 304 for different functions. For example, the security bridge 304 can compress and decompress the data stored in the storage device 302. The security bridge 304 can include error correction for the data stored in the storage device 302.

The security bridge 304 can be enabled by the authentication module 208 for accessing the storage device 302. For example, the correct PIN entry processed by the authentication module 208 can enable encryption or decryption of the data for storage into or out of the storage device 302, respectively.

The security bridge 304 can encrypt the data received from the external computing device 202 of FIG. 2 via the communication module 210 and transmits the encrypted data for storage into the storage device 302. The security bridge 304 can decrypt the data received from the storage device 302 and transmits the decrypted data to the external computing device 202 via the communication module 210.

It has also been discovered that the present invention provides the computing input system 100 providing protection of data. The protection of data can be achieved by validating the PIN using the authentication module 208. The protection of data can also be achieved by providing the authentication module 208 to enable encryption and decryption in the security bridge 304.

Referring now to FIG. 4, therein is shown a detailed diagram of the intelligent input-output controller 204. The detailed diagram depicts the intelligent input-output controller 204 having an embedded processor 402, such as a microprocessor, a central processing unit (CPU) or a hardware state machine. The embedded processor 402 can be used to execute a set of instructions or microcodes for controlling the operation of the computing input system 100 of FIG. 2.

The embedded processor 402 can be connected to the communication module 210 for communicating with the external computing device 202 of FIG. 2. The communication module 210 can enable the embedded processor 402 and the secure storage sub-system 206 to communicate with the external computing device 202.

The intelligent input-output controller 204 can include an input-output module 404, such as a human input device (HID) or a device having mouse electronics. The input-output module 404 can be used to receive signals from the left button 102, the right button 104, the wheel 106, and the display 108.

The input-output module 404 can be used to receive signals from the left button 102, the right button 104, the wheel 106, and the display 108 with the display 108 functioning as a touch pad, as an example. The input-output module 404 can be used to send signals to the display 108. The authentication module 208 can communicate with the input-output module 404 to receive the PIN.

Referring now to FIG. 5, therein is shown a system diagram of a computing input system 500 in an example application in a second embodiment of the present invention. The system diagram depicts the communication module 210 connected to the external computing device 202. The computing input system 500 can include the intelligent input-output controller 204 connected to the communication module 210.

The intelligent input-output controller 204 can be used to receive signals from the left button 102, the right button 104, the wheel 106, and the display 108 with the display 108 functioning as a touch pad, as an example. The intelligent input-output controller 204 can be used to send signals to the display 108.

The computing input system 500 can include the secure storage sub-system 206 having the security bridge 304 connected to the communication module 210. The communication module 210 can enable the intelligent input-output controller 204 and the security bridge 304 to share the communication channel 212 to communicate with the external computing device 202.

The system diagram depicts the secure storage sub-system 206 having a connector 502, such as a USB connector, a FireWire connector, or an IEEE 1394 connector. The computing input system 500 can include a removable memory 504, such as a USB drive or a removable memory card. The removable memory 504 can be connected to the security bridge 304 via the connector 502.

The security bridge 304 can interface with the authentication module 208 to authenticate the PIN. The authentication module 208 can enable the security bridge 304 to perform encryption or decryption of the data input to or output from the removable memory 504, respectively. The authentication module 208 can communicate with the intelligent input-output controller 204 to receive the PIN for enabling the security bridge 304 for accessing the removable memory 504.

The security bridge 304 can encrypt the non-encrypted data received from the communication module 210 and transmits the encrypted data to the removable memory 504. The security bridge 304 can decrypt the encrypted data received from the removable memory 504 and transmits the decrypted data to the communication module 210.

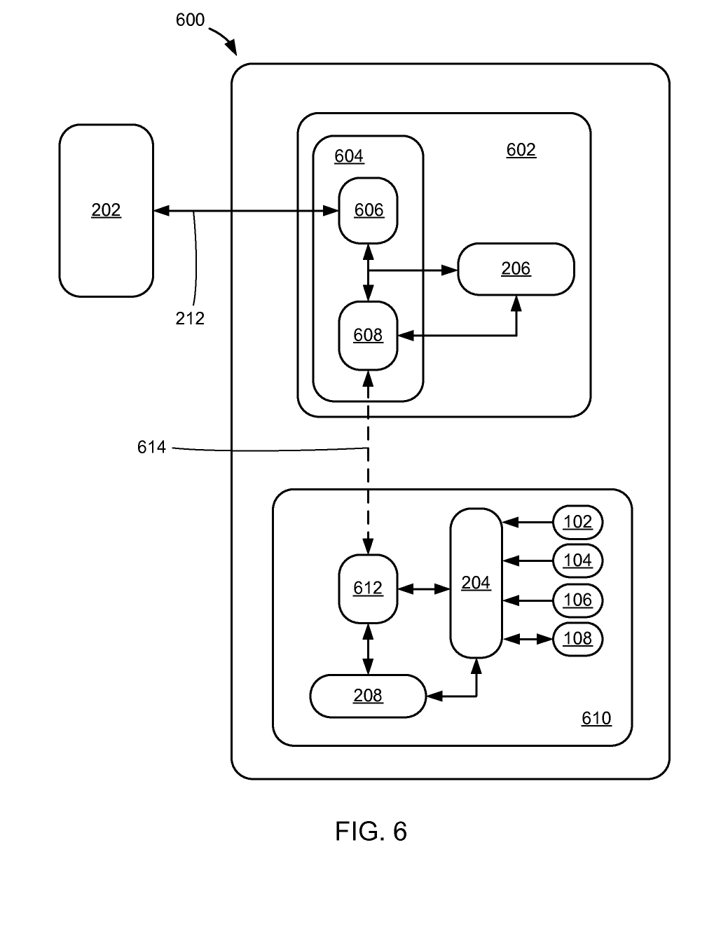

Referring now to FIG. 6, therein is shown a system diagram of a computing input system 600 in an example application in a third embodiment of the present invention. The system diagram depicts the computing input system 600 connected to the external computing device 202.

The computing input system 600 can include a dongle 602, which can be a device attached to a personal computer (PC), as an example. The dongle 602 can include a communication module 604, which can be a module that includes a hub or a bridge. The communication module 604 can support protocol such as USB, FireWire, IEEE 1394, RF, Bluetooth, 802.11x, Wi-Fi, IR, or any combination of wire and wireless technologies.

The communication module 604 can include a host interface module 606, such as a hub or a bridge. The host interface module 606 can be connected to the external computing device 202 with the communication channel 212. The communication module 604 can include a dongle transceiver 608, which can be a wireless transceiver using electromagnetic waves, RF, Bluetooth, 802.11x, Wi-Fi, or IR, to propagate signal through space.

The system diagram depicts the dongle 602 having the secure storage sub-system 206. The secure storage sub-system 206 can be connected to the communication module 604. The communication module 604 can enable the secure storage sub-system 206 and the dongle transceiver 608 to share the communication channel 212 to communicate with the external computing device 202. The secure storage sub-system 206 can be connected to the dongle transceiver 608.

The system diagram depicts the computing input system 600 having an input device 610, such as a wireless mouse, a wireless input device, or a wired input device. The input device 610 can be connected to the dongle 602. The input device 610 can include the intelligent input-output controller 204.

The intelligent input-output controller 204 can be used to receive signals from the left button 102, the right button 104, the wheel 106, and the display 108 with the display 108 functioning as a touch pad, as an example. The intelligent input-output controller 204 can be used to send signals to the display 108.

The system diagram depicts the input device 610 having a device transceiver 612, which can be a wireless transceiver using a non-physical mechanism 614, such as electromagnetic waves, RF, Bluetooth, 802.11x, Wi-Fi, or IR, to propagate signal through space. The device transceiver 612 can be wirelessly connected to the dongle transceiver 608. The device transceiver 612 can be a wired input device connected to the dongle transceiver 608.

The device transceiver 612 can be connected to the authentication module 208. The device transceiver 612 can communicate with the dongle transceiver 608 to relay commands generated by the intelligent input-output controller 204 and messages generated by the authentication module 208. The authentication module 208 can communicate with the intelligent input-output controller 204 to receive the PIN.

The behavior of the computing input system 600 can be similar to that described for the computing input system 100 of FIG. 2 and the computing input system 500 of FIG. 5. In the computing input system 600, the authentication module 208 can relay messages via the device transceiver 612 and the dongle transceiver 608 to the secure storage sub-system 206.

In the computing input system 600, the intelligent input-output controller 204 can relay commands via the device transceiver 612 and the dongle transceiver 608 to the communication module 604. The secure storage sub-system 206 can be enabled to perform encryption and decryption.

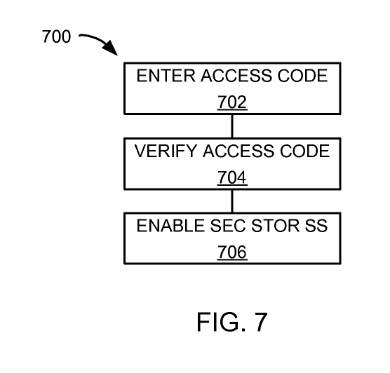

Referring now to FIG. 7, therein is shown a flow chart of a method 700 of operation of a computing input system in a further embodiment of the present invention. The method 700 includes: entering a memory access code with a button, a wheel, or a device transceiver for a non-physical mechanism in a block 702; verifying the memory access code with an authentication module in a block 704; and enabling a secure storage sub-system with the memory access code verified by the authentication module for accessing the secure storage sub-system from an external computing device in a block 706.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization.

Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method (700) of operation of a computing input system (100) comprising:
entering a memory access code (118) with a button (102), a wheel (106), or a device transceiver (612) for a non-physical mechanism (614);
verifying the memory access code (118) with an authentication module (208); and
enabling a secure storage sub-system (206) with the memory access code (118) verified by the authentication module (208) for accessing the secure storage sub-system (206) from an external computing device (202).

2. The method (700) as claimed in claim 1 wherein entering the memory access code (118) with the button (102), the wheel (106), or the device transceiver (612) includes operating a computer mouse (100) having the button (102) or the wheel (106).

3. The method (700) as claimed in claim 1 wherein entering the memory access code (118) with the button (102), the wheel (106), or the device transceiver (612) includes receiving the non-physical mechanism (614) with the device transceiver (612).

4. The method (700) as claimed in claim 1 wherein entering the memory access code (118) with the button (102), the wheel (106), or the device transceiver (612) includes:
operating a computer mouse (100) having a display (108); and
entering a positional entry (110) on the display (108) functioning as a touch pad (108) without a keypad (114) displayed.

5. The method (700) as claimed in claim 1 wherein entering the memory access code (118) with the button (102), the wheel (106), or the device transceiver (612) includes:
operating a computer mouse (100) having a display (108); and
entering the memory access code (118) with the button (102) or the wheel (106) with the display (108) showing a digit (116) for the memory access code (118).

6. A computing input system (100) comprising:
a button (102), a wheel (106), or a device transceiver (612), for a non-physical mechanism (614), for entering a memory access code (118);
an authentication module (208), coupled to a display (108), for verifying the memory access code (118); and
a secure storage sub-system (206), coupled to the authentication module (208), enabled with the memory access code (118) verified by the authentication module (208) for accessing the secure storage sub-system (206) from an external computing device (202).

7. The system (100) as claimed in claim 6 wherein the button (102), the wheel (106), or the device transceiver (612) includes a computer mouse (100) having the button (102) or the wheel (106).

8. The system (600) as claimed in claim 6 wherein the device transceiver (612) is for receiving the non-physical mechanism (614).

9. The system (100) as claimed in claim 6 wherein the button (102), the wheel (106), or the device transceiver (612) includes a computer mouse (100) having the display (108) for entering a positional entry (110) on the display (108) functioning as a touch pad (108) without a keypad (114) displayed.

10. The system (100) as claimed in claim 6 wherein the button (102), the wheel (106), or the device transceiver (612) includes a computer mouse (100) having the display (108) for entering the memory access code (118) with the button (102) or the wheel (106) with the display (108) showing a digit (116) for the memory access code (118).
